(19) United States
(12) Patent Application Publication
(10) Pub. No.: US 2023/0258248 A1
(43) Pub. Date: Aug. 17, 2023

(54) MOTOR WITH DECELERATION MECHANISM

(71) Applicant: MITSUBA Corporation, Gunma (JP)

(72) Inventors: TEPPEI TOKIZAKI, Gunma (JP); MOTOAKI KOBAYASHI, Gunma (JP); KUMIKO MASUBUCHI, Gunma (JP); TSUBASA ISHIZEKI, Gunma (JP); Yoshichika Kawashima, Gunma (JP)

(73) Assignee: MITSUBA Corporation, Gunma (JP)

(21) Appl. No.: 18/074,531

(22) Filed: Dec. 5, 2022

(30) Foreign Application Priority Data
Feb. 15, 2022 (JP) 2022-020899

(51) Int. Cl. F16H 19/08; F16H 57/04; F16H 57/021

(52) U.S. Cl. CPC F16H 19/08; F16H 57/0464; F16H 57/021; F16H 57/032

(57) ABSTRACT

The disclosure provides a motor with a deceleration mechanism capable of suppressing disengagement of gears even when a large external force is applied to an output shaft. A backup member 70 maintaining engagement between a pinion gear 61 and a helical gear 62 is provided on a side of the pinion gear 61 opposite to the side of the helical gear 62 in a gear case 20. Thus, even when a large external force is applied to the output shaft, disengagement of the gears (disengagement of the pinion gear 61 and the helical gear 62) can be suppressed. Therefore, damage to the pinion gear 61 and the helical gear 62 (deceleration mechanism 60) can be prevented for a long period of time, and consequently the life of the motor 10 with the deceleration mechanism can be extended.

### CROSS-REFERENCE TO RELATED APPLICATION

This application claims the priority benefits of Japanese Application No. 2022-020899, filed on Feb. 15, 2022. The entirety of the above-mentioned patent application is hereby incorporated by reference herein and made a part of this specification.

### BACKGROUND

### Technical Field

The disclosure relates to a motor with a deceleration mechanism, which includes a motor part having a rotating shaft and a deceleration mechanism part for decelerating rotation of the rotating shaft.

### Description of Related Art

Conventionally, a motor with a deceleration mechanism that is capable of generating a large output despite its small size has been employed as the drive source for wiper devices, power window devices, and the like mounted on vehicles such as automobiles. Such a vehicle-mounted motor with a deceleration mechanism is described in Patent Literature 1 (Japanese Patent Laid-Open No. 2020-018035), for example.

The motor with a deceleration mechanism described in Patent Literature 1 includes a brushless motor having a pinion gear, and a helical gear having an output shaft that decelerates and outputs rotation of the pinion gear. The pinion gear and the helical gear form a deceleration mechanism and are meshed with each other. In addition, the axis of the pinion gear and the axis of the output shaft are parallel to each other.

However, according to the technology described in the above Patent Literature 1, a relatively large space is formed on a side of the pinion gear opposite to the helical gear side inside a gear case. The space is required to incorporate a first ball bearing that rotatably supports the pinion gear in a predetermined location inside the gear case.

Since there is a space on the side of the pinion gear opposite to the helical gear side, for example, when a large external force is applied to the output shaft, a large load is applied to the pinion gear via the helical gear, and there is a risk that the pinion gear may bend away from the helical gear. When the pinion gear bends, the pinion gear may be disengaged from the helical gear.

The disclosure provides a motor with a deceleration mechanism that is capable of preventing disengagement of the gears even when a large external force is applied to the output shaft.

### SUMMARY

According to one aspect of the disclosure, a motor with a deceleration mechanism is provided, which includes a motor part having a rotating shaft and a deceleration mechanism part decelerating rotation of the rotating shaft, and further includes a first gear provided to be rotatable integrally with the rotating shaft; a second gear meshed with the first gear and rotated at a lower speed than the first gear; an output shaft provided in a rotation center of the second gear; and a gear case rotatably accommodating the first gear and the second gear. An engagement holding member maintaining engagement between the first gear and the second gear is provided on a side of the first gear opposite to a second gear side in the gear case.

According to the disclosure, the engagement holding member for maintaining the engagement between the first gear and the second gear is provided on the side of the first gear opposite to the second gear side in the gear case, so disengagement of the gears can be prevented even when a large external force is applied to the output shaft.

### BRIEF DESCRIPTION OF THE DRAWINGS

FIG. 1 is a cross-sectional view illustrating the internal structure of the motor with a deceleration mechanism.

FIG. 2 is a perspective view showing the inner side of the gear case.

FIG. 3 is a perspective view showing the helical gear side of the bearing holder.

FIG. 4 is an enlarged view of the dashed circle part A in FIG. 1, illustrating the gap between the components.

FIG. 5 is an exploded perspective view showing the bearing holder, the helical gear, and the gear case.

FIG. 6 is a perspective view showing the output shaft, the helical gear, the pinion gear, the rotor, and the backup member.

FIG. 7 is a perspective view showing the backup member from the side of a pair of surrounding wall portions.

FIG. 8 is a perspective view showing the backup member from the side of the fixed main body portion.

FIG. 9 is a cross-sectional view along the line B-B in FIG. 1, showing the gear case and the backup member.

FIG. 10 is an enlarged view of the dashed circle part A in FIG. 1, illustrating a moving state of grease.

FIG. 11 is a view of the arrow C in FIG. 1, illustrating the positional relationship between the helical gear and the backup member.

FIG. 12 is a perspective view illustrating the second embodiment (bearing holder).

FIG. 13 is a perspective view illustrating the third embodiment (backup member).

### DESCRIPTION OF THE EMBODIMENTS

The first embodiment of the disclosure will be described in detail below with reference to the drawings.

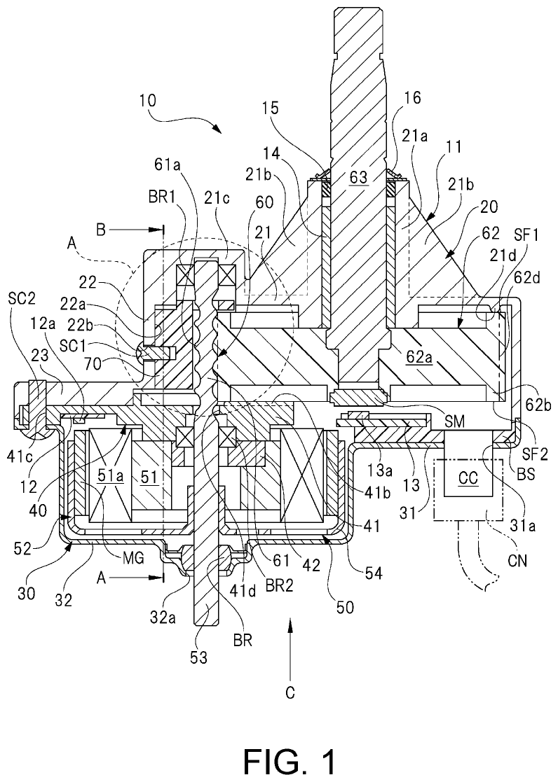

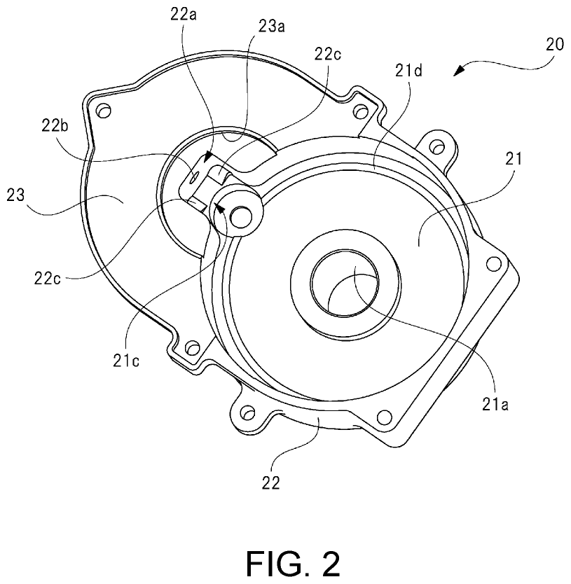

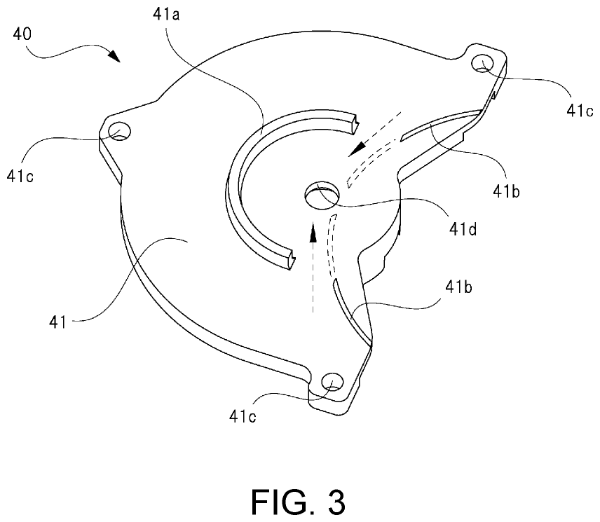

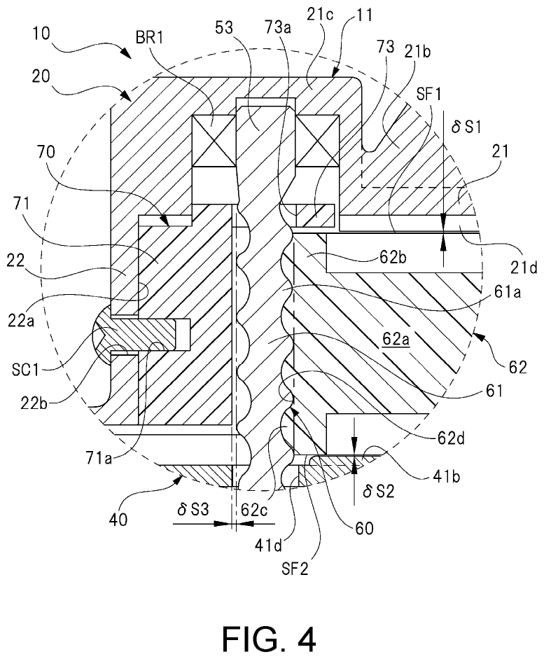

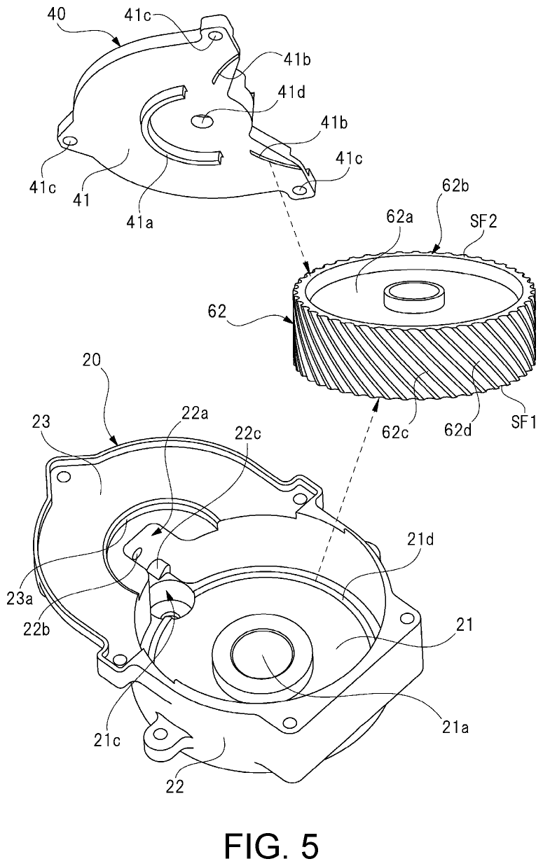

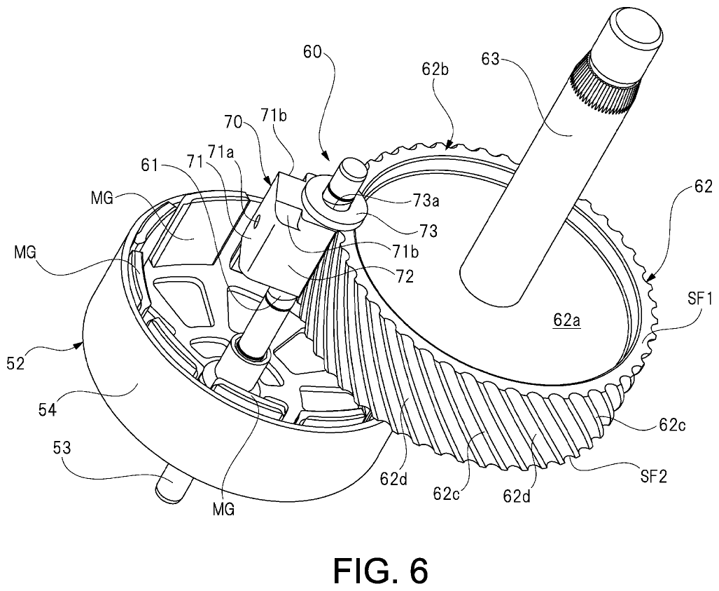

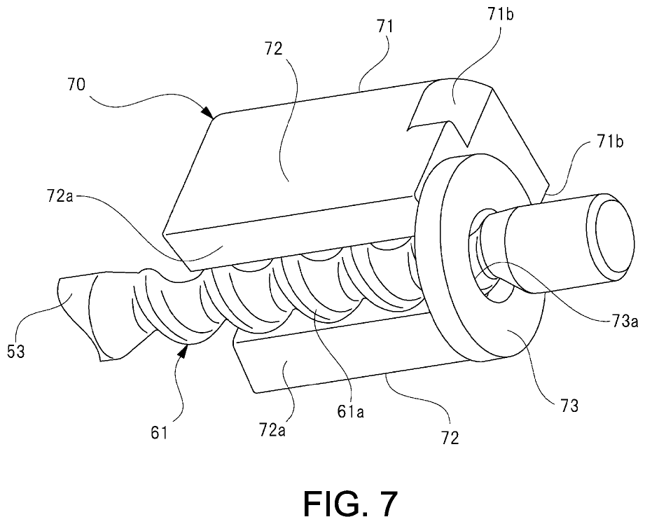

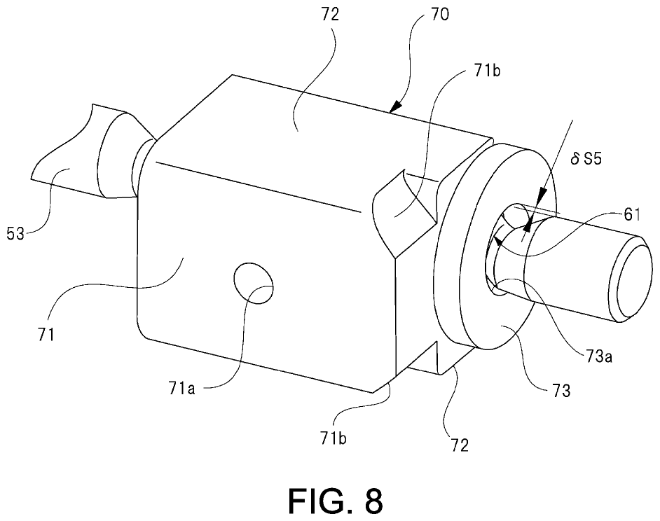

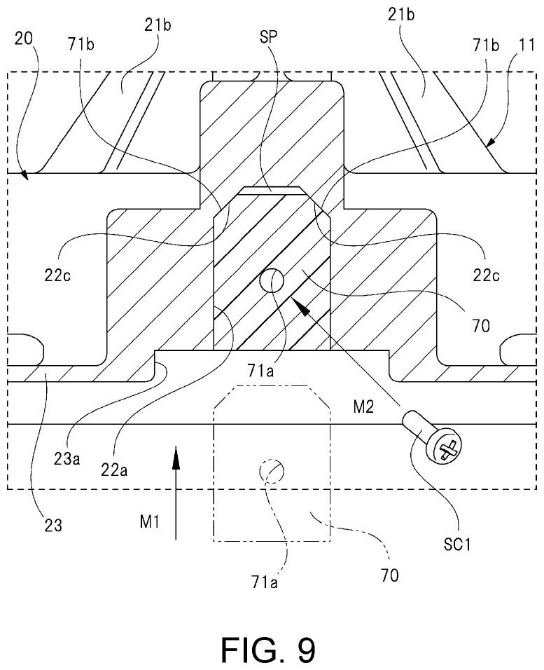

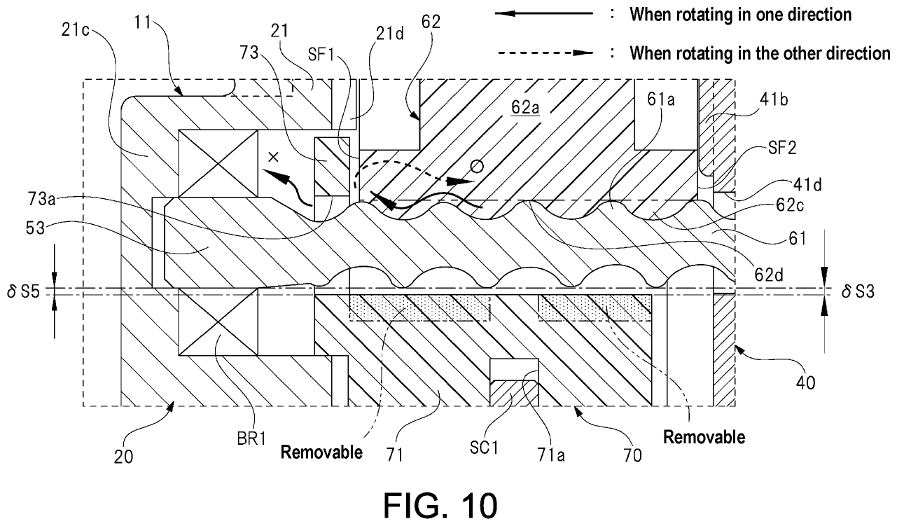

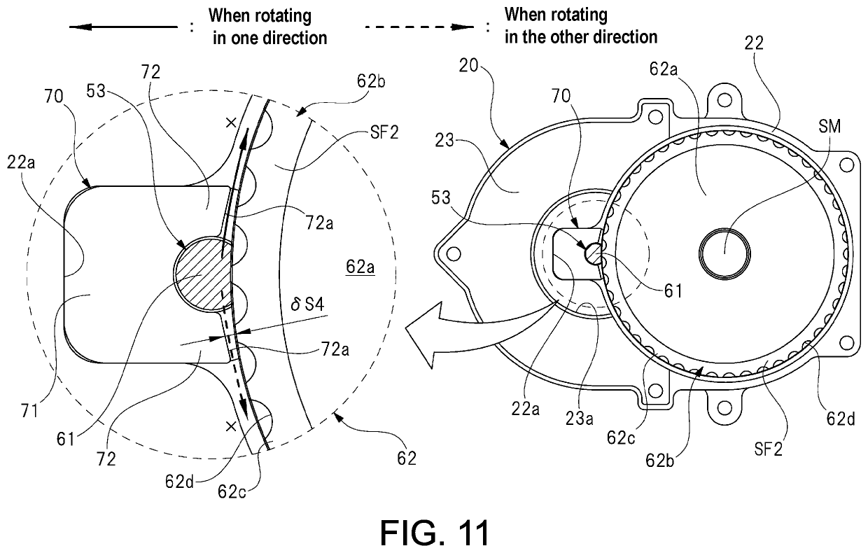

FIG. 1 is a cross-sectional view illustrating the internal structure of the motor with a deceleration mechanism. FIG. 2 is a perspective view showing the inner side of the gear case. FIG. 3 is a perspective view showing the helical gear side of the bearing holder. FIG. 4 is an enlarged view of the dashed circle part A in FIG. 1, illustrating the gap between the components. FIG. 5 is an exploded perspective view showing the bearing holder, the helical gear, and the gear case. FIG. 6 is a perspective view showing the output shaft, the helical gear, the pinion gear, the rotor, and the backup member. FIG. 7 is a perspective view showing the backup member from the side of a pair of surrounding wall portions. FIG. 8 is a perspective view showing the backup member from the side of the fixed main body portion. FIG. 9 is a cross-sectional view along the line B-B in FIG. 1, showing the gear case and the backup member. FIG. 10 is an enlarged view of the dashed circle part A in FIG. 1, illustrating a moving state of grease. FIG. 11 is a view of the arrow C in FIG. 1, illustrating the positional relationship between the helical gear and the backup member.

[Overview of Motor with Deceleration Mechanism]

A motor 10 with a deceleration mechanism shown in FIG. 1 is used, for example, as the drive source for a wiper device mounted on a vehicle such as an automobile. Specifically, the motor 10 with a deceleration mechanism is for swinging a wiper member (not shown), which is disposed in front of a windshield (not shown) of the vehicle and provided swingably on the windshield, within a predetermined wiping range between a lower reversing position and an upper reversing position.

The motor 10 with a deceleration mechanism includes a housing 11 forming the outer shell thereof. A brushless motor 50 and a deceleration mechanism 60 are rotatably accommodated inside the housing 11. The brushless motor 50 corresponds to the motor part in the disclosure, and the deceleration mechanism 60 corresponds to the deceleration mechanism part in the disclosure.

Further, a first sensor board 12 and a second sensor board 13 that are used to detect the rotation states of a rotor 52 and a helical gear 62 are respectively accommodated inside the housing 11. Then, the housing 11 includes a gear case 20 made of aluminum die cast, and a cover member formed by pressing a steel plate.

### [Gear Case]

As shown in FIG. 1 and FIG. 2, the gear case 20 is formed in a substantially bowl shape by injection molding a molten aluminum material. Specifically, the gear case 20 includes a bottom wall portion 21, a side wall portion 22 provided integrally with the periphery of the bottom wall portion 21, and a bearing holder mounting portion 23 on which the bearing holder 40 (see FIG. 3) is mounted.

A substantially central portion of the bottom wall portion 21 is provided with a cylindrical boss portion 21a that rotatably supports an output shaft 63. The boss portion 21a corresponds to the output shaft support portion in the disclosure, and a plurality of reinforcing ribs 21b formed in a substantially triangular shape are provided on the radially outer side of the boss portion 21a. These reinforcing ribs 21b are for increasing the fixing strength of the boss portion 21a to the bottom wall portion 21, and for example, eight reinforcing ribs 21b are arranged at equal intervals in the circumferential direction of the boss portion 21a.

A cylindrical bearing member 14 called a so-called “metal” is mounted on the radially inner side of the boss portion 21a. Thus, the output shaft 63 can rotate smoothly without rattling with respect to the boss portion 21a. An O-ring 15 composed of an elastic material such as rubber is mounted on the tip side (upper side in FIG. 1) and the radially inner side of the boss portion 21a. Thus, rainwater, dust, etc. are prevented from entering between the output shaft 63 and the bearing member 14.

Here, a retaining ring 16 is fixed to the longitudinal central portion of the output shaft 63. The retaining ring 16 is hooked on the tip portion of the boss portion 21a. Thus, the boss portion 21a is sandwiched between the helical gear 62 and the retaining ring 16, and the output shaft 63 is in a state of being prevented from coming off with respect to the boss portion 21a. Therefore, rattling of the output shaft 63 with respect to the boss portion 21a is suppressed, and thus quietness of the motor 10 with a deceleration mechanism is ensured.

A bearing member accommodating portion 21c is provided at a position eccentric from the boss portion 21a of the bottom wall portion 21. The bearing member accommodating portion 21c is formed in a cylindrical shape with a bottom, and protrudes from the bottom wall portion 21 toward the outer side of the gear case 20 (upper side in FIG. 1). Then, a first ball bearing BR1 that rotatably supports the tip side of the pinion gear 61 is accommodated inside the bearing member accommodating portion 21c.

A backup member accommodating portion 22a is provided in a portion of the side wall portion 22 near the bearing holder mounting portion 23. The backup member accommodating portion 22a corresponds to the engagement holding member support portion in the disclosure, and is arranged in the vicinity of the bearing member accommodating portion 21c. A backup member 70 is accommodated inside the backup member accommodating portion 22a. Here, the backup member 70 is supported by the backup member accommodating portion 22a and provided so as to cover the periphery of the pinion gear 61. Then, the backup member 70 has a function of suppressing the pinion gear 61 from bending when a large external force is applied to the output shaft 63.

Further, a single screw hole 22b is provided in the backup member accommodating portion 22a. The screw hole 22b is open in the radial direction (left-right direction in FIG. 1) of the pinion gear 61 and the helical gear 62. Then, a fixing screw SC1 for fixing the backup member 70 to the backup member accommodating portion 22a is inserted through the screw hole 22b. Thus, the backup member 70 is fixed inside the backup member accommodating portion 22a without rattling. This also ensures the quietness of the motor 10 with a deceleration mechanism.

As shown in FIG. 2 and FIG. 9, a pair of case-side inclined surfaces 22c are provided inside the backup member accommodating portion 22a. These case-side inclined surfaces 22c face each other in a direction crossing the axial direction of the pinion gear 61 and the helical gear 62 (see FIG. 1). The pair of case-side inclined surfaces 22c are arranged on the tip side in the inserting direction of the backup member 70 (see FIG. 7 and FIG. 8) into the backup member accommodating portion 22a. In other words, the pair of case-side inclined surfaces 22c are arranged on a portion of the gear case 20 near the bottom wall portion 21.

Then, a pair of backup member-side inclined surfaces 71b (see FIG. 7 to FIG. 9) provided on the backup member 70 abut against the pair of case-side inclined surfaces 22c. Thus, as indicated by the arrow M1 in FIG. 9, when the backup member 70 is mounted to the backup member accommodating portion 22a, the pair of backup member-side inclined surfaces 71b abut against the pair of case-side inclined surfaces 22c, and the backup member 70 is arranged (centered) at a prescribed position in the backup member accommodating portion 22a.

That is, the pair of case-side inclined surfaces 22c and the pair of backup member-side inclined surfaces 71b have a function of positioning the backup member 70 at a regular position with respect to the backup member accommodating portion 22a. Therefore, it is possible to easily perform the subsequent fastening operation of the fixing screw SC1 (see the arrow M2 in FIG. 9). The pair of case-side inclined surfaces 22c and the pair of backup member-side inclined surfaces 71b respectively correspond to the tapered surfaces in the disclosure.

As shown in FIG. 1 and FIG. 2, a first backup convex portion 21d formed in a substantially annular shape is provided on the inner side of the bottom wall portion 21, that is, on a side of the bottom wall portion 21 opposite to the side of the reinforcing ribs 21b. The first backup convex portion 21d has a substantially semicircular cross section and protrudes toward the inner side of the gear case 20 (lower side in FIG. 1) at a predetermined height. The first backup convex portion 21d has a function of preventing the helical gear 62 from tilting when a large external force is applied to the output shaft 63. The first backup convex portion 21d corresponds to the tilt prevention portion in the disclosure.

Further, as shown in FIG. 2, a bearing holder positioning concave portion 23a is provided in the bearing holder mounting portion 23. The bearing holder positioning concave portion 23a is provided so as to surround the periphery of the backup member accommodating portion 22a, and is recessed toward the backup member accommodating portion 22a. Then, a positioning convex portion 41a (see FIG. 3) provided on the bearing holder 40 is fitted into the bearing holder positioning concave portion 23a.

Thus, the bearing holder 40 can be mounted at a regular position with respect to the bearing holder mounting portion 23 with high accuracy. Accordingly, the subsequent fixing of the bearing holder 40 to the bearing holder mounting portion 23 using fastening screws SC2 (see FIG. 1) can be facilitated, and it is possible to coaxially arrange the second ball bearing BR2 held by the bearing holder 40 and the first ball bearing BR1 accommodated in the bearing member accommodating portion 21c with high accuracy. Therefore, variations in the rotation resistance of the pinion gear 61 for each product can be suppressed.

### [Bearing Holder]

As shown in FIG. 1 and FIG. 3, the bearing holder 40 mounted on the bearing holder mounting portion 23 holds the first sensor board 12 and the second ball bearing BR2 that rotatably supports the base end side of the pinion gear 61. The bearing holder 40 is composed of a holder main body 41 and a sub-holder 42, and is formed by abutting them against each other. Then, the second ball bearing BR2 is arranged between the holder main body 41 and the sub-holder 42.

Both the holder main body 41 and the sub-holder 42 are made of aluminum die cast, and can be firmly fixed to the gear case 20 (bearing holder mounting portion 23) without rattling. Moreover, only the holder main body 41 forming the bearing holder 40 is shown in FIG. 3.

As shown in FIG. 3, the positioning convex portion 41a, which is fitted into the bearing holder positioning concave portion 23a (see FIG. 2) and is formed in a substantially C shape, and a pair of second backup convex portions 41b formed in a substantially arc shape are provided on the holder main body 41 on the side of the helical gear 62. The protrusion height of the positioning convex portion 41a is greater than the protrusion height of the pair of second backup convex portions 41b.

Then, in a state where the bearing holder 40 (holder main body 41) is mounted on the gear case 20 (bearing holder mounting portion 23), the pair of second backup convex portions 41b are arranged to face the first backup convex portion 21d provided on the gear case 20 from the axial direction of the output shaft 63 (see FIG. 1). That is, the pair of second backup convex portions 41b also have a function of suppressing the helical gear 62 from tilting when a large external force is applied to the output shaft 63. The pair of second backup convex portions 41b also have a substantially semicircular cross section. Here, the pair of second backup convex portions 41b correspond to the tilt prevention portion in the disclosure.

A total of three screw holes 41c are provided at the outer peripheral edge of the holder main body 41. The fastening screws SC2 for fixing the cover member 30 and the bearing holder 40 to the gear case 20 are inserted through these screw holes 41c, as shown in FIG. 1. However, only one fastening screw SC2 is shown in FIG. 1.

Further, an insertion hole 41d through which the pinion gear 61 is inserted in a non-contact state is provided in the substantially central portion of the holder main body 41. The length dimension of the pair of second backup convex portions 41b is arbitrary, and is not limited to the short length dimension as indicated by the solid line in FIG. 3 and may be set to a long length dimension as indicated by the dashed arrow in the same drawing.

### [Cover Member]

As shown in FIG. 1, the cover member 30 forming the housing 11 includes a board holding portion 31 formed in a substantially flat plate shape, and a motor accommodating portion 32 formed in a substantially cylindrical shape with a bottom. The board holding portion 31 faces the helical gear 62 in the axial direction of the output shaft 63 in a state where the cover member is mounted on the gear case 20. Then, the second sensor board 13 is fixed to the inner side of the board holding portion 31 via a base member BS.

In addition, the board holding portion 31 is formed with an insertion hole 31a through which a connector connection portion CC connected with an external connector CN on the vehicle side is inserted. Here, the connector connection portion CC is fixed to the base member BS via a conductive member (not shown), and electrically connected to the first sensor board 12, the second sensor board 13, and the brushless motor 50. Thus, an in-vehicle controller (not shown) connected to the external connector CN can accurately drive the brushless motor 50 according to detection signals from the first and second sensor boards 12 and 13.

Here, three Hall sensors 12a (only one is shown in the drawing) are mounted on the first sensor board 12, and these Hall sensors 12a correspond to the U phase, V phase, and W phase, respectively. Then, the three Hall sensors 12a respectively face a permanent magnet MG provided on the rotor 52 in the axial direction of the pinion gear 61. The in-vehicle controller grasps the rotation state (rotation speed, rotation direction, etc.) of the brushless motor 50 (pinion gear 61) from the detection signals of the three Hall sensors 12a, and based on this, accurately controls the rotation state of the brushless motor 50.

On the other hand, a single MR sensor 13a is mounted on the second sensor board 13, and the MR sensor 13a faces a sensor magnet SM fixed to the rotation center of the helical gear 62 in the axial direction of the output shaft 63. Then, the in-vehicle controller grasps the rotation state (rotation position, etc.) of the output shaft 63 from the detection signal of the MR sensor 13a, and based on this, accurately controls the wiping position of the wiper member (not shown) with respect to the windshield (not shown).

In a state where the cover member 30 is mounted on the gear case 20, the motor accommodating portion 32 protrudes to the side (lower side in FIG. 1) opposite to the side of the gear case 20. In addition, in a state where the cover member 30 is mounted on the gear case 20, the motor accommodating portion 32 faces the bearing member accommodating portion 21c of the gear case 20. Then, the brushless motor 50 is accommodated inside the motor accommodating portion 32.

Furthermore, a shaft hole 32a is provided in the substantially central portion of the motor accommodating portion 32, and the bearing member BR is provided in the portion of the shaft hole 32a. Then, the bearing member BR rotatably supports the longitudinal base end side (lower side in FIG. 1) of the rotating shaft 53 of the brushless motor 50. In this way, the rotating shaft 53 including the pinion gear 61 is rotatably supported by a total of three bearings (first and second ball bearings BR1 and BR2 and bearing member BR).

### [Brushless Motor]

The brushless motor 50 accommodated in the motor accommodating portion 32 includes a stator core (stator) 51 formed in a substantially cylindrical shape. The stator core 51 is firmly fixed to the sub-holder 42 of the bearing holder 40 inside the motor accommodating portion 32 in a non-rotating state (details not shown).

The stator core 51 is formed by laminating a plurality of thin steel plates (magnetic material), and a plurality of teeth (not shown) are provided radially on the radially outer side thereof. Then, coils 51a corresponding to the U phase, V phase, and W phase are respectively wound around these teeth with a predetermined number of turns by concentrated winding.

Then, by alternately supplying drive currents to the coils 51a of the U phase, V phase, and W phase at predetermined timings through the in-vehicle controller, the rotor 52 provided on the radially outer side of the stator core 51 is rotated in a predetermined rotation direction with a predetermined drive torque. In other words, the brushless motor 50 according to the present embodiment employs an outer rotor type brushless motor.

The rotor 52 is rotatably provided on the radially outer side of the stator core 51 with a minute gap (air gap) therebetween. As shown in FIG. 1 and FIG. 6, the rotor 52 is for rotating the rotating shaft 53 provided integrally with the pinion gear 61, and includes a rotor main body 54 having a substantially U-shaped cross section, formed by pressing a steel plate (magnetic material) or the like. Then, a plurality of permanent magnets MG formed in a substantially tile shape are fixed to the radially inner side of the rotor main body 54. Further, the rotating shaft 53 provided integrally with the pinion gear 61 is firmly fixed to the rotation center of the rotor main body 54 by press fitting or the like.

### [Deceleration Mechanism]

As shown in FIG. 1 and FIG. 6, the deceleration mechanism 60 rotatably accommodated inside the housing 11 (gear case 20) includes the pinion gear (first gear) 61 that is provided integrally with the rotating shaft 53, and the helical gear (second gear) 62 that meshes with the pinion gear 61 and rotates at a lower speed than the pinion gear 61. Here, the axis of the pinion gear 61 and the axis of the helical gear 62 are parallel to each other. In other words, the rotating shaft 53 and the output shaft 63 are parallel to each other. Thus, the deceleration mechanism 60 can be made more compact in size than a worm speed reducer having a worm and a worm wheel whose axes intersect with each other.

Further, the pinion gear 61 is arranged on the side of the rotating shaft 53 (inlet side) of the motor 10 with a deceleration mechanism, and the helical gear 62 is arranged on the side of the output shaft 63 (outlet side) of the motor 10 with a deceleration mechanism. That is, the deceleration mechanism 60 reduces the high-speed rotation of the pinion gear 61 having a small number of teeth to the low-speed rotation of the helical gear 62 having a large number of teeth. Therefore, the helical gear 62 rotates at a lower speed than the pinion gear 61.

The rotating shaft 53 including the pinion gear 61 is made of metal, and the pinion gear 61 has a shape as shown in FIG. 1 and FIG. 7. Specifically, a spiral tooth (tooth) 61a is provided integrally with the periphery of the pinion gear 61, and the axial length of the spiral tooth 61a is slightly greater than the axial length of the helical gear 62. Thus, the spiral tooth 61a is reliably meshed with the helical gear 62.

The spiral tooth 61a extends spirally and continuously in the axial direction of the pinion gear 61, and the pinion gear 61 is provided with only one spiral tooth 61a. That is, the number of teeth of the pinion gear 61 is “1.” Then, the spiral tooth 61a is formed to have a circular cross-sectional shape, and enters (meshes) with a mesh recess 62d of the helical gear 62.

The helical gear 62 forming the deceleration mechanism 60 is made of plastic and has a shape as shown in FIG. 1 and FIG. 6. Specifically, the helical gear 62 includes a gear main body 62a formed in a substantially disk shape, and the base end side of the output shaft 63 is firmly fixed to the rotation center of the gear main body 62a by press fitting or the like. Thus, the output shaft 63 is rotated together with the helical gear 62. In addition, the sensor magnet SM is fixed to the rotation center of the gear main body 62a and on the side of the second sensor board 13 (lower side in FIG. 1).

A gear forming portion 62b formed in a substantially cylindrical shape is provided on the radially outer side of the gear main body 62a. A plurality of slanted teeth 62c are provided on the gear forming portion 62b so as to line up in the circumferential direction thereof. These slanted teeth 62c are inclined at a predetermined angle with respect to the axial direction of the pinion gear 61, and thus the helical gear 62 is rotated with the rotation of the spiral tooth 61a. Specifically, the mesh recess 62d is provided between the adjacent slanted teeth 62c, and the spiral tooth 61a enters and meshes with the mesh recess 62d. The mesh recess 62d is also formed to have a circular cross-sectional shape.

A first surface SF1 and a second surface SF2 are respectively provided on both axial sides of the gear forming portion 62b. Then, as shown in FIG. 1 and FIG. 5, the first surface SF1 is arranged on the side of the bottom wall portion 21 of the gear case 20, and the second surface SF2 is arranged on the side of the bearing holder 40. Furthermore, in the axial direction of the output shaft 63, the first surface SF1 faces the first backup convex portion 21d, and the second surface SF2 faces the pair of second backup convex portions 41b. Thus, the helical gear 62 is suppressed from tilting when a large external force is applied to the output shaft 63.

As shown in FIG. 4, when no large external force is applied to the output shaft 63, a minute gap δS1 is formed between the first surface SF1 and the first backup convex portion 21d. In addition, when no large external force is applied to the output shaft 63, a minute gap δS2 is formed between the second surface SF2 and the pair of second backup convex portions 41b (δS1≈δS2). Thus, during a “normal operation” of the motor with a deceleration mechanism with no large external force applied to the output shaft 63, the helical gear 62 can rotate smoothly without contacting both the gear case 20 and the bearing holder 40.

In contrast, during an “overload operation” of the motor with a deceleration mechanism with a large external force applied to the output shaft 63, the helical gear 62 tends to tilt with respect to the axis of the output shaft 63 due to the inclination of the slanted teeth 62c. Then, depending on the rotation direction of the helical gear 62, the first surface SF1 contacts the first backup convex portion 21d (see the dashed arrow in FIG. 5), and the second surface SF2 contacts the pair of second backup convex portions 41b (see the dashed arrow in FIG. 5). As a result, the helical gear 62 is supported (backed up) by the first and second backup convex portions 21d and 41b, and is suppressed from tilting further. Accordingly, deterioration of the state of engagement between the helical gear 62 and the pinion gear 61 is suppressed, and the helical gear 62 made of plastic is prevented from being gouged out and damaged by the pinion gear 61 made of metal.

Here, the number of slanted teeth 62c (mesh recesses 62d) provided on the helical gear 62 is “40.” That is, in the present embodiment, the speed reduction ratio of the deceleration mechanism 60 including the pinion gear 61 and the helical gear 62 is “40.”

### [Backup Member]

As shown in FIG. 1, FIG. 4, and FIG. 6 to FIG. 8, the backup member 70 accommodated in the backup member accommodating portion 22a of the gear case 20 is formed in a substantially rectangular parallelepiped shape by injection molding a resin material such as plastic. The backup member 70 includes a fixed main body portion 71 fixed to the gear case 20, a pair of surrounding wall portions 72 provided integrally with the fixed main body portion 71 and surrounding the periphery of the pinion gear 61 together with the fixed main body portion 71, and an annular wall portion 73 provided integrally with one longitudinal side (right side in FIG. 7 and FIG. 8) of these surrounding wall portions 72 and formed in a substantially annular shape.

The fixed main body portion 71 is provided with a female screw portion 71a. The female screw portion 71a corresponds to the fixing portion in the disclosure, and is provided in the central portion of the backup member 70 in the longitudinal direction of the pinion gear 61. Further, the female screw portion 71a is arranged on the side (rear surface side) of the fixed main body portion 71 opposite to the side of the pinion gear 61. Then, the fixing screw SC1 is fastened to the female screw portion 71a to fix the backup member 70 to the gear case 20.

In addition, the pair of backup member-side inclined surfaces 71b are provided on one longitudinal side (right side in FIG. 7 and FIG. 8) of the fixed main body portion 71. These backup member-side inclined surfaces 71b respectively abut against the pair of case-side inclined surfaces 22c (see FIG. 2 and FIG. 9) provided on the gear case 20. Here, as shown in FIG. 9, in a state where the backup member-side inclined surfaces 71b are abutted against the case-side inclined surfaces 22c, a space SP is formed between the tip portion in the inserting direction of the backup member 70 and the bottom portion of the backup member accommodating portion 22a. Thus, the pair of backup member-side inclined surfaces 71b can be abutted against the pair of case-side inclined surfaces 22c without rattling, and the positioning accuracy of the backup member 70 with respect to the gear case 20 is improved.

As shown in FIG. 1, FIG. 4, FIG. 6, and FIG. 10, in a state where the backup member 70 is assembled to the gear case 20, the fixed main body portion 71 forming the backup member 70 is provided on the side of the pinion gear 61 opposite to the side of the helical gear 62 in the gear case 20. Then, a minute gap (clearance) δS3 is formed between the pinion gear 61 and the fixed main body portion 71. Here, the minute gap δS3 has substantially the same clearance dimension as the minute gap δS1 between the first surface SF1 and the first backup convex portion 21d and the minute gap δS2 between the second surface SF2 and the pair of second backup convex portions 41b (δS1≈δS2≈δS3).

Thus, during the “normal operation” of the motor 10 with a deceleration mechanism with no large external force applied to the output shaft 63, a load that bends the pinion gear 61 is not applied from the helical gear 62 to the pinion gear 61, so the pinion gear 61 can rotate smoothly without contacting the backup member 70.

In addition, since the boss portion 21a that supports the output shaft 63 and the backup member accommodating portion 22a that supports the backup member 70 are respectively provided in the gear case 20 that is made of aluminum and formed with high accuracy, it is possible to arrange the positions of the output shaft 63 and the backup member 70 with high accuracy. Accordingly, this also makes it possible to narrow the minute gap δS3 between the pinion gear 61 and the fixed main body portion 71 while keeping the pinion gear 61 smoothly rotatable without contacting the backup member 70.

On the other hand, during the “overload operation” of the motor 10 with a deceleration mechanism with a large external force applied to the output shaft 63, the helical gear 62 tends to tilt with respect to the axis of the output shaft 63 due to the inclination of the slanted teeth 62c. Thus, a large lateral force is applied to the pinion gear 61 from the radially outer side thereof. Then, although the pinion gear 61 is made of metal, the portion where the pinion gear 61 is provided is particularly thin, so it is vulnerable to the load from the lateral direction. As a result, the pinion gear 61 is pressed by the helical gear 62 from the radial direction and tends to bend.

In this case, the substantially central portion of the pinion gear 61 in the longitudinal direction is pressed by the helical gear 62. Therefore, the substantially central portion of the pinion gear 61 in the longitudinal direction is brought into contact with the fixed main body portion 71. Since the substantially central portion of the pinion gear 61 in the longitudinal direction is supported (backed up) by the fixed main body portion 71, the pinion gear 61 is suppressed from bending further, and the state of engagement between the pinion gear 61 and the helical gear 62 is maintained. Here, the backup member 70 corresponds to the engagement holding member in the disclosure.

As the pinion gear 61 bends, the substantially central portion of the fixed main body portion 71 in the longitudinal direction is pressed, but the substantially central portion of the fixed main body portion 71 in the longitudinal direction is a portion that is fixed to the gear case 20 by the fixing screw SC1 and is least likely to rattle. Accordingly, even if the pinion gear 61 bends repeatedly, the backup member 70 can support the pinion gear 61 without rattling with respect to the gear case 20. Therefore, the backup member 70 is effectively suppressed from being damaged at an early stage.

Furthermore, the minute gap δS3 between the pinion gear 61 and the fixed main body portion 71 is set to a clearance dimension that prevents disengagement of the pinion gear 61 from the helical gear 62. In addition, as shown in FIG. 4 and FIG. 10, in the present embodiment, the fixed main body portion 71 is provided over substantially the entire area of the pinion gear 61 in the longitudinal direction, but as described above, it is known that the substantially central portion of the pinion gear 61 in the longitudinal direction is bent during the “overload operation” of the motor 10 with a deceleration mechanism. Therefore, the fixed main body portion 71 of the backup member 70 is arranged at least in the longitudinal central portion of the pinion gear 61. Specifically, the hatched portions surrounded by the two-dot chain lines in FIG. 10 can be removed. In this case, the weight of the backup member 70 can be reduced, and the thick portion of the backup member 70 can be reduced to improve the molding accuracy of the backup member 70.

Moreover, as shown in FIG. 11, the pair of surrounding wall portions 72 extend from the fixed main body portion 71 toward the helical gear 62, and a minute gap δS4 is formed between the tip side of these surrounding wall portions 72 and the helical gear 62. These surrounding wall portions 72 are provided on both sides of the backup member 70 in the rotation direction of the helical gear 62, and correspond to the second grease leakage prevention wall in the disclosure. Then, inclined surfaces 72a are respectively provided on the tip side of the pair of surrounding wall portions 72 so as to incline in the circumferential direction of the helical gear 62, and these inclined surfaces 72a extend in the circumferential direction of the helical gear 62 so as to follow the outer peripheral shape of the helical gear 62. Therefore, the space between the pair of inclined surfaces 72a and the helical gear 62 can be narrowed to form the minute gap δS4.

Here, as shown in FIG. 11, by forming the minute gap δS4 between the pair of surrounding wall portions 72 and the helical gear 62, when the helical gear 62 rotates in one direction, as indicated by the solid arrow X, grease (not shown) applied to the meshing portion between the pinion gear 61 and the helical gear 62 is prevented from leaking out of the surrounding wall portions 72. On the other hand, even when the helical gear 62 rotates in the other direction, as indicated by the dashed arrow X, grease applied to the meshing portion between the pinion gear 61 and the helical gear 62 is prevented from leaking out of the surrounding wall portions 72.

The minute gap δS4 has substantially the same clearance dimension as the minute gap δS1 between the first surface SF1 and the first backup convex portion 21d, the minute gap δS2 between the second surface SF2 and the pair of second backup convex portions 41b, and the minute gap δS3 between the pinion gear 61 and the fixed main body portion 71 (δS1≈δS2≈δS3≈δS4). Besides, one of the pair of surrounding wall portions 72 can also be removed and provided on at least one side of the backup member 70 in the rotation direction of the helical gear 62. In this case, one single surrounding wall portion 72 still prevents grease from leaking out of the surrounding wall portion 72.

As shown in FIG. 7 and FIG. 8, the annular wall portion 73 is provided on one side (right side in FIG. 7 and FIG. 8) of the backup member 70 in the longitudinal direction of the pinion gear 61, and a pinion gear insertion hole 73a is provided in the substantially central portion of the annular wall portion 73. The pinion gear 61 is rotatably inserted through the pinion gear insertion hole 73a without contacting the pinion gear insertion hole 73a, and a minute gap 855 is formed between the pinion gear 61 and the pinion gear insertion hole 73a (see FIG. 8).

The minute gap δS5 has the same clearance dimension as the minute gap δS3 between the pinion gear 61 and the fixed main body portion 71 (δS3=δS5).

By forming the minute gap δS5 between the pinion gear 61 and the pinion gear insertion hole 73a in this way, as shown in FIG. 10, when the pinion gear 61 rotates in one direction, grease (not shown) which tends to move as indicated by the solid arrow is prevented from going over the annular wall portion 73 and leaking out of the annular wall portion 73 (see the solid arrow X). Then, the grease driven to the portion of the annular wall portion 73 when the pinion gear 61 rotates in one direction is returned toward the longitudinal central portion of the pinion gear 61 as indicated by the dashed arrow ◯ when the pinion gear 61 rotates in the other direction. The annular wall portion 73 corresponds to the first grease leakage prevention wall in the disclosure.

Here, in the present embodiment, the motor 10 with a deceleration mechanism is used as the drive source for a wiper device. Accordingly, when the wiper member (not shown) is swung, the pinion gear 61 and the helical gear 62 are respectively rotated in forward and reverse directions at predetermined cycles. Therefore, as shown in FIG. 10, by repeatedly rotating the pinion gear 61 and the helical gear 62 in one direction (forward rotation) and in the other direction (reverse rotation), the grease moves back and forth in the axial direction of the pinion gear 61 on the inner side of the backup member 70. In other words, it is possible to keep the grease in the meshing portion between the pinion gear 61 and the helical gear 62 for a long period of time.

In a state where the backup member 70 is accommodated in the backup member accommodating portion 22a and the pair of backup member-side inclined surfaces 71b respectively abut against the pair of case-side inclined surfaces 22c, the annular wall portion 73 enters the opening of the bearing member accommodating portion 21c provided in the gear case (see FIG. 1, FIG. 4, and FIG. 10). Thus, the backup member 70 is prevented from rattling inside the gear case 20.

As described in detail above, according to the present embodiment, the backup member 70 for maintaining the engagement between the pinion gear 61 and the helical gear 62 is provided on the side of the pinion gear 61 opposite to the side of the helical gear 62 in the gear case 20, so disengagement of the gears (disengagement of the pinion gear 61 and the helical gear 62) can be prevented even when a large external force is applied to the output shaft 63.

Thus, damage to the pinion gear 61 and the helical gear 62 (deceleration mechanism 60) can be prevented for a long period of time, and consequently the life of the motor 10 with a deceleration mechanism can be extended. In other words, in the present embodiment, since the life of the motor 10 with a deceleration mechanism can be extended, energy for manufacturing the motor 10 with a deceleration mechanism can be saved, and consequently it is possible to achieve Goal 7 (affordable and clean energy for all) and Goal 13 (specific measures against climate change) in the United Nations Sustainable Development Goals (SDGs).

Further, according to the present embodiment, since the minute gap δS3 is provided between the pinion gear 61 and the fixed main body portion 71 of the backup member 70, during the “normal operation” of the motor 10 with a deceleration mechanism with no large external force applied to the output shaft 63, the pinion gear 61 can be smoothly rotated without contacting the backup member 70. Therefore, it is possible to effectively suppress the generation of abnormal noise from the motor 10 with a deceleration mechanism, and to apply the motor 10 with a deceleration mechanism to a vehicle such as an electric vehicle that requires quietness.

Furthermore, according to the present embodiment, since the gear case 20 includes the boss portion 21a that supports the output shaft 63 and the backup member accommodating portion 22a that supports the backup member 70, the positions of the output shaft 63 and the backup member 70 can be arranged with high accuracy. Therefore, it is possible to narrow the minute gap δS3 between the pinion gear 61 and the fixed main body portion 71 while keeping the pinion gear 61 smoothly rotatable without contacting the backup member 70, and it is possible to prevent the motor 10 with a deceleration mechanism from being unnecessarily large.

Moreover, according to the present embodiment, the backup member 70 and the backup member accommodating portion 22a respectively include the pair of backup member-side inclined surfaces 71b and the pair of case-side inclined surfaces 22c for positioning the backup member 70 with respect to the backup member accommodating portion 22a. Accordingly, when the backup member 70 is mounted in the backup member accommodating portion 22a, the pair of backup member-side inclined surfaces 71b can abut against the pair of case-side inclined surfaces 22c to arrange (center) the backup member 70 at a prescribed position in the backup member accommodating portion 22a. Therefore, it is possible to easily assemble the motor 10 with a deceleration mechanism.

Furthermore, according to the present embodiment, the rotating shaft 53 and the output shaft 63 are provided parallel to each other, and the pinion gear 61 has one spiral tooth 61a and the helical gear 62 has the slanted teeth 62c with which the one spiral tooth 61a is meshed. Thus, it is possible to obtain a large speed reduction ratio while keeping the deceleration mechanism 60 compact. Therefore, it is possible to reduce the size of the motor 10 with a deceleration mechanism, and to easily apply the motor 10 with a deceleration mechanism to a small vehicle such as a light car.

In addition, according to the present embodiment, the backup member 70 can also be arranged at least in the longitudinal central portion of the pinion gear 61. In other words, as shown in FIG. 10, the hatched portions surrounded by the two-dot chain lines can also be removed. In that case, the weight of the backup member 70 can be reduced, and the thick portion of the backup member 70 can be reduced to improve the molding accuracy of the backup member 70 (injection molded product).

Furthermore, according to the present embodiment, the female screw portion 71a for fixing the backup member 70 to the gear case 20 is provided in the central portion of the backup member 70 in the longitudinal direction of the pinion gear 61. Accordingly, when the pinion gear 61 bends, the portion of the fixed main body portion 71 that is least likely to rattle is pressed, and even if the pinion gear 61 bends repeatedly, the backup member 70 can support the pinion gear 61 without rattling with respect to the gear case 20. Therefore, it is possible to prevent the backup member 70 from being damaged at an early stage.

Moreover, according to the present embodiment, the annular wall portion 73 that prevents leakage of the grease applied between the pinion gear 61 and the helical gear 62 is provided on one side (right side in FIG. 7 and FIG. 8) of the backup member 70 in the longitudinal direction of the pinion gear 61. Accordingly, as shown in FIG. 10, when the pinion gear 61 rotates in one direction, the grease which tends to move as indicated by the solid arrow can be prevented from going over the annular wall portion 73 and leaking out of the annular wall portion 73. Therefore, it is possible to keep the grease in the meshing portion between the pinion gear 61 and the helical gear 62 for a long period of time, and consequently smoothly operate the motor with a deceleration mechanism for a long period of time.

Furthermore, according to the present embodiment, the pair of surrounding wall portions 72 that prevent leakage of the grease applied between the pinion gear 61 and the helical gear 62 are provided on both sides of the backup member 70 in the rotation direction of the helical gear 62. Accordingly, as shown in FIG. 11, when the helical gear 62 rotates in one direction and in the other direction, the grease applied to the meshing portion between the pinion gear 61 and the helical gear 62 can be prevented from leaking out of the surrounding wall portions 72. This also allows the motor 10 with a deceleration mechanism to operate smoothly for a long period of time.

In addition, according to the present embodiment, the gear case 20 includes the first backup convex portion 21d and the second backup convex portions 41b that prevent the helical gear 62 from tilting with respect to the gear case 20. Accordingly, the helical gear 62 can be prevented from tilting when a large external force is applied to the output shaft 63, and consequently the helical gear 62 made of plastic can be prevented from being damaged at an early stage to extend the life of the motor 10 with a deceleration mechanism.

### Second Embodiment

Next, the second embodiment of the disclosure will be described in detail with reference to the drawings. It should be noted that portions having functions similar to those of the first embodiment described above are denoted by the same reference numerals, and detailed description thereof will be omitted.

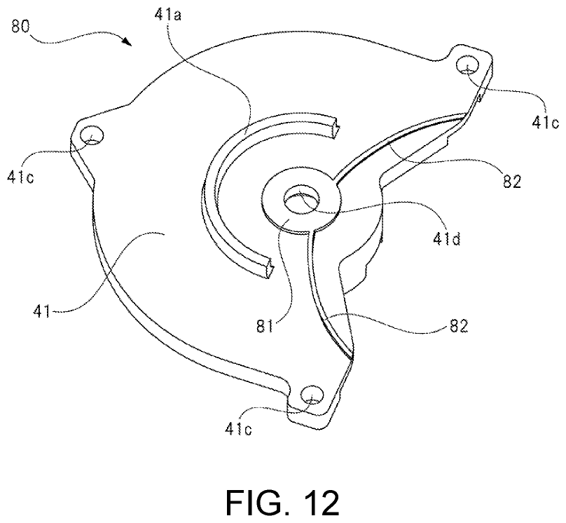

FIG. 12 shows a perspective view illustrating the second embodiment (bearing holder).

As shown in FIG. 12, compared to the bearing holder 40 (see FIG. 3) of the first embodiment, the bearing holder 80 of the second embodiment has a difference that an annular base portion 81 is provided on the periphery of the insertion hole 41d of the holder main body 41 on the side of the positioning convex portion 41a. Another difference is that a pair of second backup convex portions (tilt prevention portion) 82 are extended so as to be connected to the annular base portion 81.

The annular base portion 81 is a portion that faces the other longitudinal side (lower side in FIG. 1) of the backup member 70 (surrounding wall portions 72) in the assembled state of the motor 10 with a deceleration mechanism (see FIG. 1). Thus, with the annular base portion 81, similar to the annular wall portion 73 (see FIG. 7 and FIG. 8) of the backup member 70, grease is also prevented from going over the annular base portion 81 and leaking out of the annular base portion 81.

Also, in the second embodiment formed as described above, it is possible to achieve the same effects as the first embodiment described above. In addition, in the second embodiment, since the bearing holder 80 is provided with the annular base portion 81, grease is suppressed from reaching the brushless motor 50. Therefore, the leaked grease can be prevented from adversely affecting the operation of the brushless motor 50. Furthermore, since the pair of second backup convex portions 82 are extended to be connected to the annular base portion 81, it is possible to further prevent the helical gear 62 from tilting.

### Third Embodiment

Next, the third embodiment of the disclosure will be described in detail with reference to the drawings. It should be noted that portions having functions similar to those of the first embodiment described above are denoted by the same reference numerals, and detailed description thereof will be omitted.

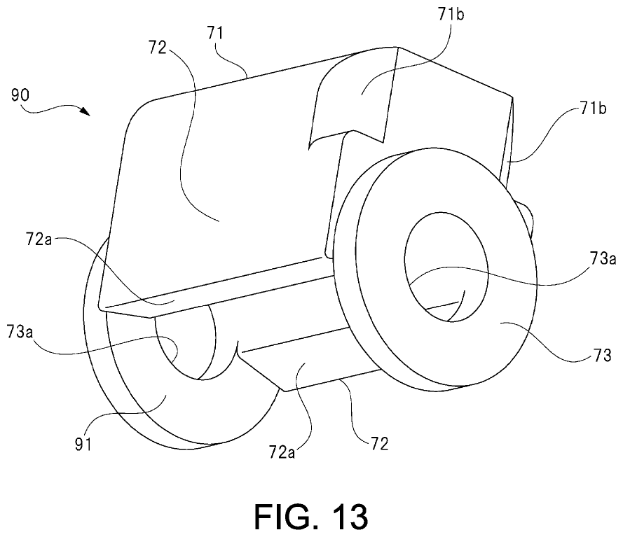

FIG. 13 shows a perspective view illustrating the third embodiment (backup member).

As shown in FIG. 13, compared to the backup member 70 of the first embodiment (see FIG. 7 and FIG. 8), the backup member 90 of the third embodiment has a difference that the other annular wall portion (first grease leakage prevention wall) 91 is provided on the other side (corresponding to the right side in FIG. 7 and FIG. 8) in the longitudinal direction of the pinion gear 61. The other annular wall portion 91 is also provided with a pinion gear insertion hole 73a similar to that of the annular wall portion 73. Then, the other annular wall portion 91 faces the annular wall portion 73 in the longitudinal direction of the pair of surrounding wall portions 72.

Also, in the third embodiment formed as described above, it is possible to achieve the same effects as the first embodiment described above. In addition, in the third embodiment, since the other annular wall portion 91 is provided on the other side (the side of the brushless motor 50) of the backup member 70, grease is suppressed from reaching the brushless motor 50 as in the second embodiment described above. Therefore, the leaked grease can be prevented from adversely affecting the operation of the brushless motor 50.

It goes without saying that the disclosure is not limited to the above-described embodiments, and that various modifications can be made without departing from the spirit of the disclosure. For example, although the above embodiments illustrate that the motor 10 with a deceleration mechanism is used as the drive source for a wiper device mounted on a vehicle, the disclosure is not limited thereto, and the motor 10 with a deceleration mechanism can also be used as other drive sources for a power window device, a sunroof device, etc.

Moreover, although the above embodiments illustrate the motor 10 with a deceleration mechanism including the brushless motor 50, the disclosure is not limited thereto, and a motor with a brush may be used as the motor part.

In addition, the material, shape, size, number, installation location, etc. of each component in each of the above embodiments are arbitrary as long as the disclosure can be achieved, and are not limited to each of the above embodiments.

What is claimed is:

1. A motor with a deceleration mechanism, comprising:
a motor part having a rotating shaft;
a deceleration mechanism part decelerating rotation of the rotating shaft;
a first gear provided to be rotatable integrally with the rotating shaft;
a second gear meshed with the first gear and rotated at a lower speed than the first gear;
an output shaft provided in a rotation center of the second gear; and
a gear case rotatably accommodating the first gear and the second gear,
wherein an engagement holding member maintaining engagement between the first gear and the second gear is provided on a side of the first gear opposite to a second gear side in the gear case.

2. The motor with the deceleration mechanism according to claim 1, wherein a gap is provided between the first gear and the engagement holding member.

3. The motor with the deceleration mechanism according to claim 1, wherein the gear case comprises:
an output shaft support portion supporting the output shaft; and
an engagement holding member support portion supporting the engagement holding member.

4. The motor with the deceleration mechanism according to claim 2, wherein the gear case comprises:
an output shaft support portion supporting the output shaft; and
an engagement holding member support portion supporting the engagement holding member.

5. The motor with the deceleration mechanism according to claim 3, wherein the engagement holding member and the engagement holding member support portion respectively comprise tapered surfaces for positioning the engagement holding member with respect to the engagement holding member support portion.

6. The motor with the deceleration mechanism according to claim 1, wherein the rotating shaft and the output shaft are provided parallel to each other,
the first gear is a pinion gear having one tooth, and
the second gear is a helical gear comprising slanted teeth with which the one tooth is meshed.

7. The motor with the deceleration mechanism according to claim 2, wherein the rotating shaft and the output shaft are provided parallel to each other,
the first gear is a pinion gear having one tooth, and
the second gear is a helical gear comprising slanted teeth with which the one tooth is meshed.

8. The motor with the deceleration mechanism according to claim 3, wherein the rotating shaft and the output shaft are provided parallel to each other,
the first gear is a pinion gear having one tooth, and
the second gear is a helical gear comprising slanted teeth with which the one tooth is meshed.

9. The motor with the deceleration mechanism according to claim 5, wherein the rotating shaft and the output shaft are provided parallel to each other,
the first gear is a pinion gear having one tooth, and
the second gear is a helical gear comprising slanted teeth with which the one tooth is meshed.

10. The motor with the deceleration mechanism according to claim 6, wherein the engagement holding member is arranged at least in a longitudinal central portion of the pinion gear.

11. The motor with the deceleration mechanism according to claim 10, wherein a fixing portion for fixing the engagement holding member to the gear case is provided in a central portion of the engagement holding member in a longitudinal direction of the pinion gear.

12. The motor with the deceleration mechanism according to claim 6, wherein a first grease leakage prevention wall that prevents leakage of grease applied between the pinion gear and the helical gear is provided on at least one side of the engagement holding member in the longitudinal direction of the pinion gear.

13. The motor with the deceleration mechanism according to claim 6, wherein a second grease leakage prevention wall that prevents leakage of grease applied between the pinion gear and the helical gear is provided on at least one side of the engagement holding member in a rotation direction of the helical gear.

14. The motor with the deceleration mechanism according to claim 1, wherein the gear case comprises a tilt prevention portion preventing the second gear from tilting with respect to the gear case.
